(19) United States
(12) Patent Application Publication
(10) Pub. No.: US 2026/0367479 A1
(43) Pub. Date: Nov. 19, 2026

(54) VARIABLE APERTURE, CAMERA MODULE, AND ELECTRONIC DEVICE

(71) Applicant: AAC Microtech (Changzhou) Co., Ltd., Changzhou City (CN)

(72) Inventors: Zhiwei Zhong, Changzhou (CN); Xin Jin, Changzhou (CN); Wei Song, Changzhou (CN); Weiwei Tao, Changzhou (CN)

(21) Appl. No.: 19/291,612

(22) Filed: Aug. 6, 2025

Related U.S. Application Data
(63) Continuation of application No. PCT/CN2025/094892, filed on May 14, 2025.

(51) Int. Cl. G03B 9/06; G03B 30/00

(52) U.S. Cl. CPC G03B 9/06; G03B 30/00

(57) ABSTRACT

Disclosed are a variable aperture, a camera module, and an electronic device. The variable aperture includes: a base, a rotatable bracket rotatably connected to the base, a plurality of blades rotatably connected to the base and slidably connected to the rotatable bracket, and a magnetic circuit structure configured to drive the rotatable bracket to rotate. A first through-hole is defined in the base, a second through-hole is defined in the rotatable bracket, and the plurality of blades enclose to define an aperture hole. The first through-hole, the second through-hole, and the aperture hole are aligned. The magnetic circuit structure includes a first magnet and a second magnet, a coil securely, and a yoke.

### CROSS REFERENCE TO RELATED APPLICATIONS

The present application is a continuation of PCT Patent Application No. PCT/CN2025/094892, entitled “VARIABLE APERTURE, CAMERA MODULE, AND ELECTRONIC DEVICE,” filed on May 14, 2025, which is incorporated by reference herein in its entirety.

### TECHNICAL FIELD

The present disclosure relates to the technical fled of cameras, and in particular, relates to a variable aperture, a camera module, and an electronic device.

### BACKGROUND

Electronic devices in daily life, such as mobile phones, are typically equipped with camera modules. These camera modules adjust a size of an aperture hole a variable aperture to adapt to different lighting conditions, thereby achieving dynamic adjustment of light intake. In the related art, an electromagnetic drive is typically employed to change the size of the aperture hole of the variable aperture. In conventional variable apertures, magnet structures are typically arranged based on a Halbach array configuration, thereby defining an elongated magnet structure. Furthermore, a rectangular coil is disposed above this magnet structure. With such a configuration, only two opposing short sides of the coil provide an effective drive force. This arrangement may easily result in the coil having an ineffective length, leading to low power efficiency and low magnetic field utilization for the coil.

Therefore, a variable aperture with a new magnetic circuit structure is desired.

### SUMMARY

An object of the present disclosure is to provide a magnetic circuit structure that ensures the entire coil is situated within an effective magnetic field region, thereby achieving high coil power and magnetic circuit utilization, and generating a greater drive force.

The present disclosure employs the following technical solution:

According to a first aspect of embodiments of the present disclosure, a variable aperture is provided. The variable aperture includes: a base; a rotatable bracket rotatably connected to the base; a plurality of blades rotatably connected to the base and slidably connected to the rotatable bracket; and a magnetic circuit structure configured to drive the rotatable bracket to rotate, wherein a first through-hole is defined in the base, a second through-hole is defined in the rotatable bracket, and the plurality of blades enclose to define an aperture hole, the first through-hole, the second through-hole, and the aperture hole being aligned; wherein the magnetic circuit structure includes a first magnet and a second magnet securely connected to the base and spaced apart from each other along a first direction, a coil securely assembled to the rotatable bracket and surrounding an outer periphery of the first magnet and/or the second magnet, and a yoke secured to the base and disposed on a side of the coil facing away from the first magnet and/or the second magnet, wherein magnetization directions of the first magnet and the second magnet are opposite to each other and are both parallel to the first direction.

In some embodiments, the magnetic circuit structure further include at least one third magnet; wherein the third magnet is secured to one end of the first magnet along the magnetization direction of the first magnet and is assembled between the first magnet and the yoke, and a magnetization direction of the third magnet points toward the first magnet; and/or, wherein the third magnet is secured to one end of the second magnet along the magnetization direction of the second magnet and is assembled between the second magnet and the yoke, and a magnetization direction of the third magnet points toward the second magnet.

In some embodiments, the yoke includes a first yoke plate disposed on the side of the coil facing away from the first magnet; wherein the third magnet is securely assembled between the first magnet and the first yoke plate; and/or, the third magnet is secured assembled between the second magnet and the first yoke plate.

In some embodiments, the magnetization direction of the third magnet is orthogonal to the magnetization direction of the first magnet, and a magnetic pole of the third magnet at an end proximate to the first magnet is opposite to a magnetic pole of the first magnet at an end proximate to the third magnet; and/or, the magnetization direction of the third magnet is orthogonal to the magnetization direction of the second magnet, and a magnetic pole of the third magnet at an end proximate to the second magnet is opposite to a magnetic pole of the second magnet at an end proximate to the third magnet.

In some embodiments, the yoke further includes a second yoke plate connected to the first yoke plate and arranged orthogonally to the first yoke plate; wherein the third magnet is securely assembled between the first magnet and the second yoke plate, and/or, the third magnet is securely assembled between the second magnet and the second yoke plate.

In some embodiments, the magnetic circuit structure further includes an iron core securely connected to the base, and the first magnet and the second magnet are connected via the iron core along the first direction.

In some embodiments, the variable aperture further includes: a plurality of magnetic circuit structures spaced apart along a circumferential direction of the base.

In some embodiments, an accommodating space is defined between the base and the rotatable bracket, the accommodating space being spaced apart from the first through-hole, and at least a portion of the magnetic circuit structure is assembled within the accommodating space; and a first slide slot is defined in an outer periphery of the base, the first slide slot being in communication with the accommodating space and extending along a circumferential direction; a first slide block protrudes from a side of the rotatable bracket axially facing the base, the first slide block being movable along the first slide slot; wherein the coil is securely connected to a side of the first slide block that faces the accommodating space along a side radially facing away from the first magnet and/or the second magnet.

According to a first aspect of embodiments of the present disclosure, a camera module is provided. The camera module includes: a lens module and the variable aperture as described above, wherein the variable aperture is securely connected to the lens module, and the variable aperture is disposed on a light-incident side of a lens of the lens module.

According to a third aspect of embodiments of the present disclosure, an electronic device is provided. The electronic device includes the camera module as described above.

The present disclosure achieves the following beneficial effects: The variable aperture includes the base, the rotatable bracket, the plurality of blades, and the magnetic circuit structure. The magnetic circuit structure may drive the rotatable bracket to rotate. The rotatable bracket may, in turn, drive the plurality of blades to rotate relative to the base and to slide relative to the rotatable bracket. That is, the movement of the plurality of blades may be controlled via the magnetic circuit structure, such that a size of the aperture hole defined by the plurality of blades is adjusted, and hence light intake is adjusted. Specifically, the magnetic circuit structure includes a first magnet and a second magnet spaced apart from each other along a first direction, such that the first magnet and the second magnet define an elongated magnet structure. Compared to a ring-shaped magnet structure, a spacing between the magnets in an elongated magnet structure may be smaller, such that a magnetic field having a greater strength is generated. Additionally, the coil surrounds the outer periphery of the first magnet and/or the second magnet, and the magnetization directions of the first magnet and the second magnet are opposite. This means that the magnetic poles of the first magnet and the second magnet at their ends proximate to each other along the first direction are the same. Furthermore, with the yoke disposed on the side of the coil facing away from the magnets, the magnetic field generated by the first magnet and the second magnet may be concentrated at the coil after the coil is energized. This configuration ensures that the entire coil is situated within an effective region of the magnetic field, which improves magnetic field utilization and enhance the drive force. Moreover, the first magnet and the second magnet are secured relative to the base, and the coil is secured relative to the rotatable bracket. When the coil is energized, an inductive effect between the coil and the magnets causes the coil to rotate, thereby driving the rotatable bracket to rotate. As the coil is lightweight compared to the magnets, the rotation of the coil and the rotatable bracket is more responsive, such that faster start-stop speeds are achieved for the variable aperture. During the process of adjusting the size of the aperture hole, the blades follow the movement of the coil and may rapidly reach their designated positions, achieving a zero-delay adjustment. When arriving at the designated positions, the blades exhibit minimal to no jitter, which leads to a precise aperture value. This also reduces the runtime and frequency of interventions from a closed-loop control system, thereby reducing power consumption.

### BRIEF DESCRIPTION OF THE DRAWINGS

FIG. 1 is a schematic perspective view of a magnetic circuit structure according to the present disclosure;

FIG. 2 is a top view of the magnetic circuit structure in FIG. 1.

FIG. 3 is a schematic cross-sectional view of the magnetic circuit structure taken along line A-A in FIG. 2.

FIG. 4 is a schematic perspective view of a variable aperture according to the present disclosure;

FIG. 5 is a schematic view of a partial structure of the variable aperture according to the present disclosure; and

FIG. 6 is an exploded view of the variable aperture according to the present disclosure.

Reference numerals and denotations thereof:
10–magnetic circuit structure; 1–first magnet; 2–second magnet; 3–coil; 4–yoke; 41–first yoke plate; 42–second yoke plate; 5–third magnet; 6–iron core;
20–base; 201–first through-hole; 202–first slide slot; 203–pivot post; 30–rotatable bracket; 301–second through-hole; 302–first slide block; 303–connecting post;
40–blade; 401–aperture hole; 402–pivot hole; 403–slide hole;
50–cover; 501–third through-hole.

### DETAILED DESCRIPTION

In the description of some embodiments of the present application, it should be understood that the terms "central," "transversal," "longitudinal," "length," "width," "thickness," "upper," "lower," "front," "rear," "left," "right," "vertical," "horizontal," "top," "bottom," "inner," "outer," "clockwise," "counterclockwise," "axial," "radial," "circumferential," and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present application.

In addition, terms of "first" and "second" are only used for description, but shall not be understood as indication or implication of relative importance or implicit indication of the number of the specific technical features. Therefore, the features defined by the terms "first" and "second" may explicitly or implicitly include one or more of these features. In the description of the present disclosure, the term "more" or "a plurality of" signifies at least two, unless otherwise specified.

The present disclosure is further described with reference to and the attached drawings and specific embodiments.

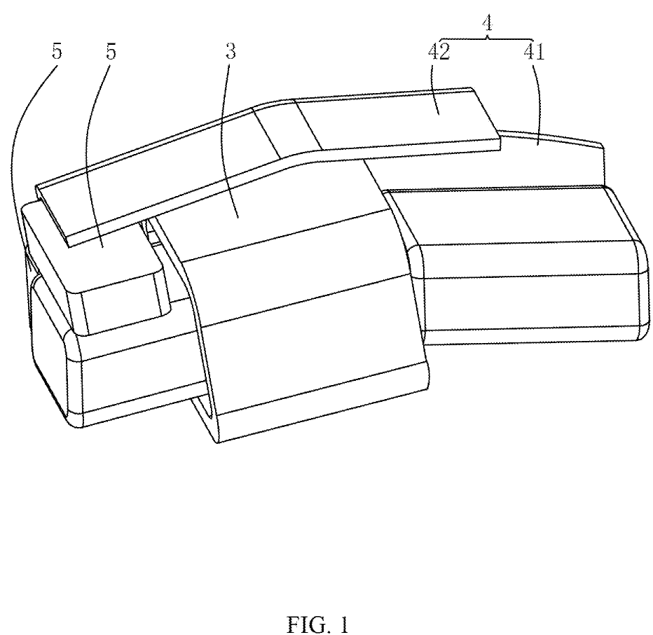

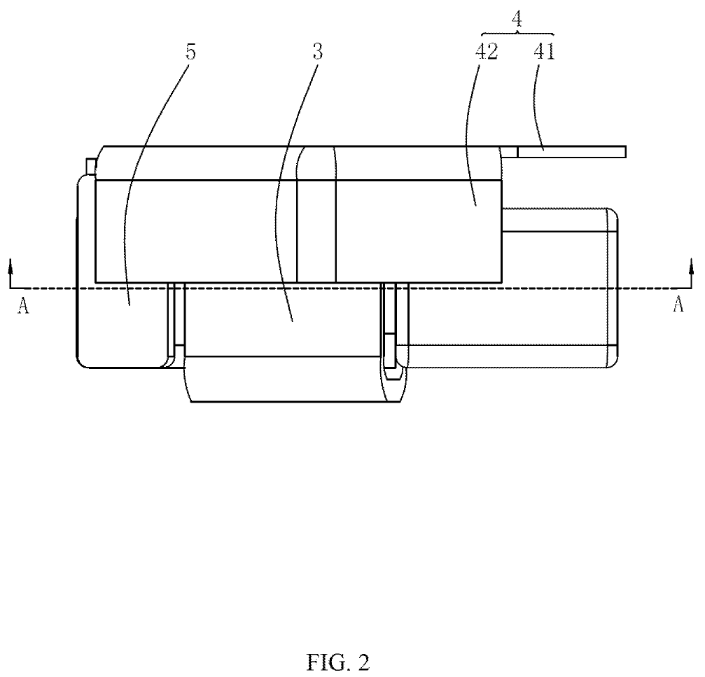

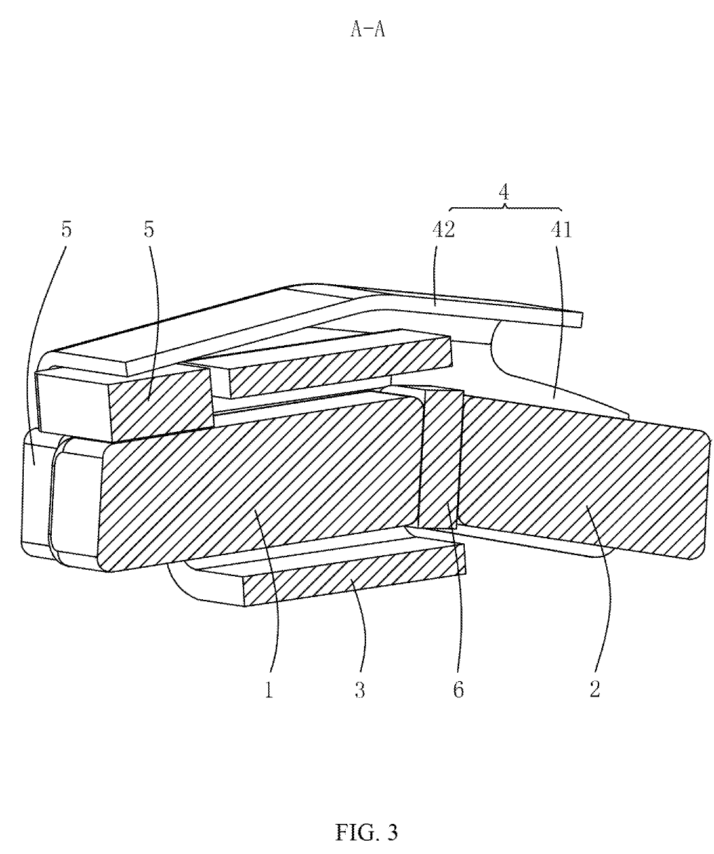

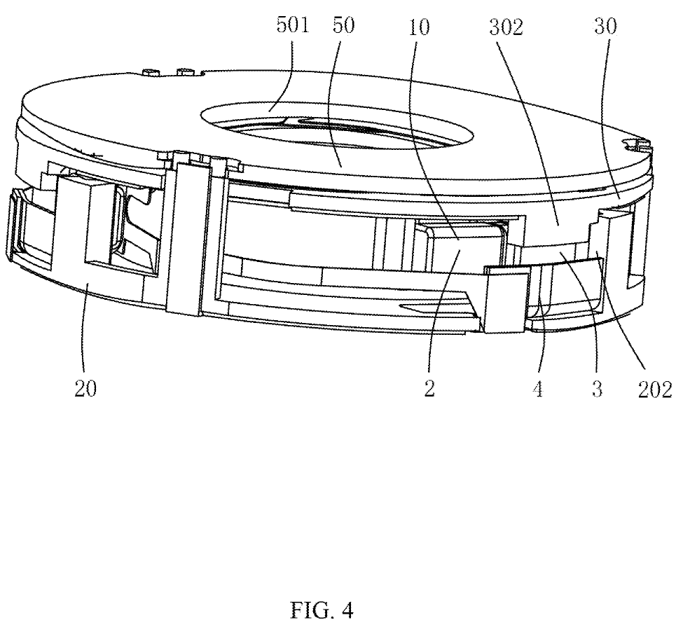

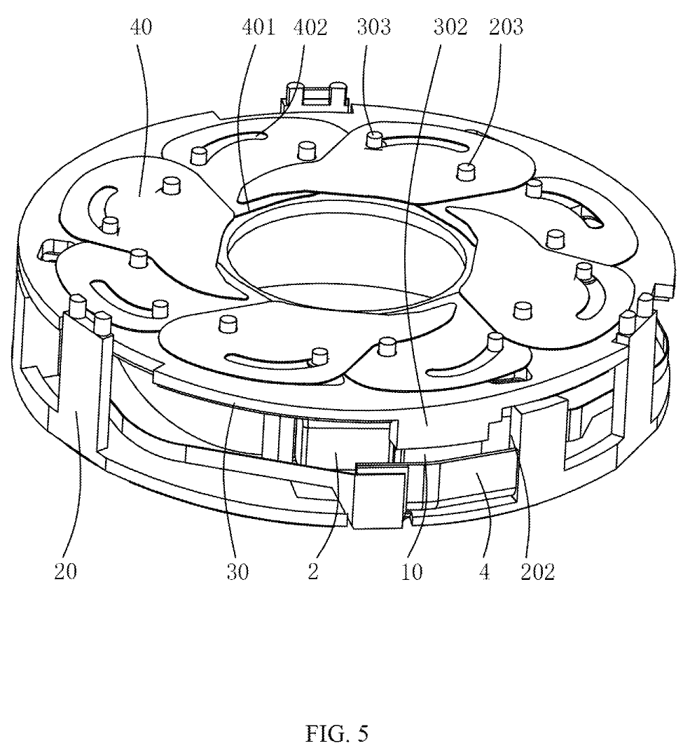

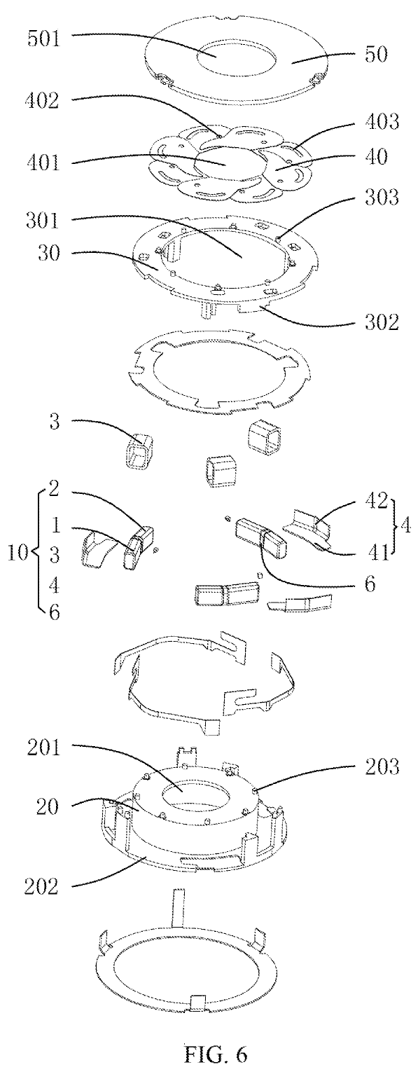

Referring to FIGS. 1-6, some embodiments of the present disclosure provide a variable aperture. The variable aperture includes: a base 20, a rotatable bracket 30 rotatably connected to the base 20, a plurality of blades 40 rotatably connected to the base 20 and slidably connected to the rotatable bracket 30, and a magnetic circuit structure 10 configured to drive the rotatable bracket 30 to rotate. A first through-hole 201 is defined in the base 20, a second through-hole 301 is defined in the rotatable bracket 30, and the plurality of blades 40 enclose to define an aperture hole 401. The first through-hole 201, the second through-hole 301, and the aperture hole 401 are aligned. The magnetic circuit structure 10 includes a first magnet 1 and a second magnet 2 securely connected to the base 20 and spaced apart from each other along a first direction, a coil 3 securely assembled to the rotatable bracket 30 and surrounding an outer periphery of the first magnet 1 and/or the second magnet 2, and a yoke 4 secured to the base 20 and disposed on a side of the coil 3 facing away from the first magnet 1 and/or the second magnet 2. Furthermore, magnetization directions of the first magnet 1 and the second magnet 2 are opposite to each other and are both parallel to the first direction.

In the embodiments of the present disclosure, the variable aperture includes the base 20, the rotatable bracket 30, the plurality of blades 40, and the magnetic circuit structure 10. The magnetic circuit structure 10 may drive the rotatable bracket 30 to rotate. The rotatable bracket 30 may, in turn, drive the plurality of blades 40 to rotate relative to the base 20 and to slide relative to the rotatable bracket 30. That is, the movement of the plurality of blades 40 may be controlled via the magnetic circuit structure 10, such that a size of the aperture hole 401 defined by the plurality of blades 40 is adjusted, and hence light intake is adjusted. Specifically, the magnetic circuit structure includes a first magnet 1 and a second magnet 2 spaced apart from each other along a first direction, such that the first magnet 1 and the second magnet 2 define an elongated magnet structure. Compared to a ring-shaped magnet structure, a spacing between the magnets in an elongated magnet structure may be smaller, such that a magnetic field having a greater strength is generated. Additionally, the coil 3 surrounds the outer periphery of the first magnet 1 and/or the second magnet 2, and the magnetization directions of the first magnet 1 and the second magnet 2 are opposite. This means that the magnetic poles of the first magnet 1 and the second magnet 2 at their ends proximate to each other along the first direction are the same. Furthermore, with the yoke 4 disposed on the side of the coil 3 facing away from the magnets, magnetic fields generated by the first magnet 1 and the second magnet 2 may be concentrated at the coil 3 after the coil 3 is energized. This configuration ensures that the entire coil 3 is situated within an effective region of the magnetic field, which improves magnetic field utilization and enhance the drive force. Furthermore, the first magnet 1 and the second magnet 2 are secured relative to the base 20, and the coil 3 and the rotatable bracket 30 are secured relative to each other. After the coil 3 is energized, the coil 3 and the magnets interact via induction, such that the rotation of the coil 3 is enabled to drive the rotatable bracket 30 to rotate. As the coil 3 is lightweight compared to the magnets, the rotation of the coil 3 and the rotatable bracket 30 is more responsive, such that faster start-stop speeds are achieved for the variable aperture. During the process of adjusting the size of the aperture hole 401, the blades 40 follow the movement of the coil 3 and may rapidly reach their designated positions, achieving a zero-delay adjustment. When arriving at the designated positions, the blades 40 exhibit minimal to no jitter, which leads to a precise aperture value. This also reduces the runtime and frequency of interventions from a closed-loop control system, thereby reducing power consumption.

It is to be understood that the magnetic circuit structure 10 according to the embodiments of the present disclosure may also be connected to other structural components or parts of the variable aperture in other ways. Exemplarily, in the variable aperture, the coil 3 may be securely assembled to the base 20, and the first magnet 1 and the second magnet 2 may be securely assembled to the rotatable bracket 30. This allows the first magnet 1 and the second magnet 2 to drive the rotatable bracket 30 to rotate, which in turn drives the blades 40 to move. Similarly, this configuration also ensures that the entire coil 3 is situated within an effective region of the magnetic field, such that magnetic field utilization is improved and the drive force is enhanced. In addition, the magnetic circuit structure 10 is enabled to better drive the rotatable bracket 30, and consequently better drive the blades 40 to better achieve the adjustment of the size of the aperture hole 401, which is not described in detail herein.

It is also to be understood that the magnetic circuit structure 10 according to the embodiments of the present disclosure may also be applied to other types of variable apertures. Exemplarily, in addition to the base 20, the rotatable bracket 30, and the blades 40, the variable aperture may further include other structural components or parts, such as ball bearings. Similarly, by adopting the magnetic circuit structure 10 according to the embodiments of the present disclosure, the entire coil 3 is enabled to be situated within an effective region of the magnetic field, such that magnetic field utilization is improved and the drive force is enhanced. In addition, the magnetic circuit structure 10 is enabled to better drive the rotatable bracket 30, and consequently better drive the blades 40 to better achieve the adjustment of the size of the aperture hole 401, which is not described in detail herein.

Further, referring to FIGS. 1-3 and 6, in some specific embodiments, the magnetization directions of the first magnet 1 and the second magnet 2 are both parallel to the first direction. Furthermore, the magnetization direction of the first magnet 1 points toward the second magnet 2, and the magnetization direction of the second magnet 2 points toward the first magnet 1. That is, N-poles of the first magnet 1 and the second magnet 2 are set to face each other. Since the coil 3 is disposed between the first magnet 1 and the second magnet 2 and is situated on the outer periphery of the magnets, after the coil 3 is energized, a magnetic field generated by the first magnet 1 and a magnetic field generated by the second magnet 2 may both be concentrated at the coil 3 more effectively and directly. This allows for a better improvement in magnetic field utilization and a further enhancement of the drive force.

Further, referring to FIGS. 1-3, the magnetic circuit structure 10 further includes at least one third magnet 5. The third magnet 5 is secured to an end of the first magnet 1 along the magnetization direction thereof and is assembled between the first magnet 1 and the yoke 4, and a magnetization direction of the third magnet 5 points toward the first magnet 1; and/or, the third magnet 5 is secured to one end of the second magnet 2 along the magnetization direction thereof and is assembled between the second magnet 2 and the yoke 4, and a magnetization direction of the third magnet 5 points toward the second magnet 2.

In some embodiments, the yoke 4 is disposed on the side of the coil 3 facing away from the magnets. A first assembly gap is present between the yoke 4 and the first magnet 1, and at least one third magnet 5 may be disposed in the first assembly gap and at an end of the first magnet 1 along the magnetization direction thereof. Concurrently, the magnetization direction of the third magnet 5 points toward the first magnet 1, and a magnetic pole of the third magnet 5 at an end proximate to the first magnet 1 is opposite to a magnetic pole of the first magnet 1 at an end proximate to the third magnet 5. In this way, after the coil 3 is energized, magnetic flux lines generated by the third magnet 5 and magnetic flux lines generated by the first magnet 1 may be superimposed, which enhances the magnetic field strength and consequently enhances the drive force.

In some embodiments, a second assembly gap is present between the yoke 4 and the second magnet 2. Similarly, at least one third magnet 5 may be disposed in the second assembly gap and at an end of the second magnet 2 along the magnetization direction thereof. Concurrently, the magnetization direction of the third magnet 5 points toward the second magnet 2, and a magnetic pole of the third magnet 5 at an end proximate to the second magnet 2 is opposite to a magnetic pole of the second magnet 2 at an end proximate to the third magnet 5. In this way, after the coil 3 is energized, magnetic flux lines generated by the third magnet 5 and magnetic flux lines generated by the second magnet 2 may be superimposed, which enhances the magnetic field strength and consequently enhances the drive force.

In some embodiments, at least one third magnet 5 may be disposed in the first assembly gap, and at least one third magnet 5 is disposed in the second assembly gap. This further enhances the magnetic field strength and further enhances the drive force, which is not described in detail herein.

Further, referring to FIGS. 1-3, and 6, in some specific embodiments, the yoke 4 is disposed on the side of the coil 3 facing away from the magnets. A first assembly gap is present between the yoke 4 and the first magnet 1, and at least one third magnet 5 may be disposed in the first assembly gap. The third magnet 5 is disposed at an end of the first magnet 1 distant from the coil 3 along the magnetization direction. Concurrently, an N-pole of the third magnet 5 is made to point toward an S-pole of the first magnet 1, while an S-pole of the third magnet 5 faces the yoke 4. In this way, after the coil 3 is energized, magnetic flux lines generated by the third magnet 5 and magnetic flux lines generated by the first magnet 1 may be superimposed, and the superimposed magnetic flux lines may be directly concentrated at the coil 3. This enhances the magnetic field strength, improves magnetic field utilization, and better enhances the drive force.

In some specific embodiments, a second assembly gap is present between the yoke 4 and the second magnet 2. Similarly, at least one third magnet 5 may be disposed in the second assembly gap. The third magnet 5 is positioned at an end of the second magnet 2 distant from the coil 3 along the magnetization direction. Concurrently, an N-pole of the third magnet 5 is made to point toward an S-pole of the second magnet 2, while an S-pole of the third magnet 5 faces the yoke 4. In this way, after the coil 3 is energized, magnetic flux lines generated by the third magnet 5 and magnetic flux lines generated by the second magnet 2 may be superimposed, and the superimposed magnetic flux lines can be directly concentrated at the coil 3. This enhances the magnetic field strength, improves magnetic field utilization, and better enhances the drive force.

Further, referring to FIGS. 1-3, and 6, in some embodiments, the yoke 4 includes a first yoke plate 41 disposed on a side of the coil 3 facing away from the first magnet 1. The third magnet 5 is securely assembled between the first magnet 1 and the first yoke plate 41; and/or, the third magnet 5 is securely assembled between the second magnet 2 and the first yoke plate 41.

Exemplarily, the first yoke plate 41 is disposed on a side of the coil 3 facing away from the magnets. The first yoke plate 41 is elongated in shape. Furthermore, the first yoke plate 41 extends from one end of the first magnet 1 to a proximate region between the first magnet 1 and the second magnet 2, and then continues to extend to the other end of the second magnet 2. This ensures that a yoke structure is disposed on the outer side of both the first magnet 1 and the second magnet 2. Consequently, the first yoke plate 41 may concentrate the magnetic field generated by the first magnet 1 and the magnetic field generated by the second magnet 2, such that the magnetic fields generated by both the first magnet 1 and the second magnet 2 are concentrated at the coil 3. This improves magnetic field utilization and enhances the drive force. Additionally, by disposing the third magnet(s) 5 between the first yoke plate 41 and the first magnet 1, and/or between the first yoke plate 41 and the second magnet 2, the magnetic field strength of the first magnet 1 and/or the second magnet 2 is enhanced, which enhances the drive force.

In other embodiments, the first yoke plate 41 may extend from one end of the first magnet 1 to the proximate region between the first magnet 1 and the second magnet 2, and then continue to extend to a central position along the length of the second magnet 2. This also concentrates the magnetic field generated by the first magnet 1 and the magnetic field generated by the second magnet 2.

Further, referring to FIGS. 1-3, and 6, in some embodiments, the magnetization direction of the third magnet 5 is orthogonal to the magnetization direction of the first magnet 1, and a magnetic pole of the third magnet 5 at an end proximate to the first magnet 1 is opposite to a magnetic pole of the first magnet 1 at an end proximate to the third magnet 5; and/or, the magnetization direction of the third magnet 5 is orthogonal to the magnetization direction of the second magnet 2, and a magnetic pole of the third magnet 5 at an end proximate to the second magnet 2 is opposite to a magnetic pole of the second magnet 2 at an end proximate to the third magnet 5.

Specifically, the first yoke plate 41 is elongated in shape, and a surface of the first yoke plate 41 is arranged parallel to a surface of the first magnet 1. A third magnet 5 may be disposed between the first magnet 1 and the first yoke plate 41, such that one end of the third magnet 5 points toward the surface of the first magnet 1 and the other end points toward the surface of the first yoke plate 41. Furthermore, the magnetization direction of the third magnet 5 is arranged orthogonally to the magnetization direction of the first magnet 1, and the magnetic poles of the third magnet 5 and the first magnet 1 at their proximate ends are opposite. In this way, the magnetic flux lines generated by the third magnet 5 and the magnetic flux lines generated by the first magnet 1 may be superimposed, and the superposition effect may be improved, thereby better enhancing the magnetic field strength and generating a stronger drive force. Additionally, the surface of the first yoke plate 41 is further arranged parallel to a surface of the second magnet 2. A third magnet 5 may be disposed between the second magnet 2 and the first yoke plate 41, such that one end of the third magnet 5 points toward the surface of the second magnet 2 and the other end points toward the surface of the first yoke plate 41. Furthermore, the magnetization direction of the third magnet 5 is arranged orthogonally to the magnetization direction of the second magnet 2, and the magnetic poles of the third magnet 5 and the second magnet 2 at their proximate ends are opposite. In this way, the magnetic flux lines generated by the third magnet 5 and the magnetic flux lines generated by the second magnet 2 may be superimposed, and the superposition effect may be improved, thereby better enhancing the magnetic field strength and generating a greater drive force.

It is to be understood that the embodiments of the present disclosure do not limit an angular relationship between the magnetization direction of the third magnet 5 and the magnetization direction of the first magnet 1, nor an angular relationship between the magnetization direction of the third magnet 5 and the magnetization direction of the second magnet 2. By changing these respective angles, the degree of superposition of the magnetic flux lines may be adjusted.

Further, in some specific embodiments, a third magnet 5 may be disposed between the first magnet 1 and the first yoke plate 41. The third magnet 5 is disposed at the end of the first magnet 1 distant from the coil 3 along the magnetization direction. Concurrently, the third magnet 5 and the first magnet 1 are arranged orthogonally, and the N-pole of the third magnet 5 is made to point toward the S-pole of the first magnet 1, and the S-pole of the third magnet 5 faces the first yoke plate 41. In this way, after the coil 3 is energized, the magnetic flux lines generated by the third magnet 5 and the magnetic flux lines generated by the first magnet 1 may be superimposed, and the superimposed magnetic flux lines may be directly concentrated at the coil 3. This enhances the magnetic field strength, improves magnetic field utilization, and better enhances the drive force.

Further, in some specific embodiments, a third magnet 5 may be disposed between the second magnet 2 and the first yoke plate 41. The third magnet 5 is disposed at the end of the second magnet 2 distant from the coil 3 along the magnetization direction. Concurrently, the third magnet 5 and the second magnet 2 are arranged orthogonally, and the N-pole of the third magnet 5 is made to point toward the S-pole of the second magnet 2, and the S-pole of the third magnet 5 faces the first yoke plate 41. In this way, after the coil 3 is energized, the magnetic flux lines generated by the third magnet 5 and the magnetic flux lines generated by the second magnet 2 may be superimposed, and the superimposed magnetic flux lines may be directly concentrated at the coil 3. This enhances the magnetic field strength, improves magnetic field utilization, and better enhances the drive force.

Further, referring to FIGS. 1-3, and 6, in some embodiments, the yoke 4 further includes a second yoke plate 42 connected to the first yoke plate 41 and arranged orthogonally to the first yoke plate 41. The third magnet 5 is securely assembled between the first magnet 1 and the second yoke plate 42; and/or, the third magnet 5 is securely assembled between the second magnet 2 and the second yoke plate 42.

Exemplarily, the yoke 4 further includes the second yoke plate 42 arranged orthogonally to the first yoke plate 41. The second yoke plate 42 likewise extends along the length of the first magnet 1. The second yoke plate 42 extends from one end of the first magnet 1 to the proximate region between the first magnet 1 and the second magnet 2, and then continues to extend to a central position along the length of the second magnet 2. This also causes the magnetic flux lines generated by the first magnet 1 to be concentrated at the coil 3, and also guides the magnetic flux lines generated by the second magnet 2 to concentrate toward the coil 3. Additionally, by disposing the third magnet(s) 5 between the first yoke plate 41 and the first magnet 1, and/or between the first yoke plate 41 and the second magnet 2, the magnetic field strength of the first magnet 1 and/or the second magnet 2 is enhanced, which enhances the drive force.

In other embodiments, the second yoke plate 42 may extend from one end of the first magnet 1 to the proximate region between the first magnet 1 and the second magnet 2, and then continue to extend to the other end of the second magnet 2. This also concentrates the magnetic field generated by the first magnet 1 and the magnetic field generated by the second magnet 2.

Further, in some specific embodiments, a third magnet 5 may be disposed between the first magnet 1 and the second yoke plate 42. The third magnet 5 is disposed at the end of the first magnet 1 distant from the coil 3 along the magnetization direction. Concurrently, the third magnet 5 and the second magnet 2 are arranged orthogonally, and the N-pole of the third magnet 5 is made to point toward the S-pole of the first magnet 1, and the S-pole of the third magnet 5 faces the second yoke plate 42. In this way, after the coil 3 is energized, the magnetic flux lines generated by the third magnet 5 and the magnetic flux lines generated by the first magnet 1 may be superimposed, and the superimposed magnetic flux lines may be directly concentrated at the coil 3. This enhances the magnetic field strength, improves magnetic field utilization, and better enhances the drive force.

It is to be understood that the embodiments of the present disclosure do not limit an angular relationship between the magnetization direction of the third magnet 5 and the magnetization direction of the first magnet 1, nor an angular relationship between the magnetization direction of the third magnet 5 and the magnetization direction of the second magnet 2. By changing these respective angles, the degree of superposition of the magnetic flux lines may be adjusted.

Further, referring to FIGS. 1-3, and 6, in some embodiments, the magnetic circuit structure 10 further includes an iron core 6 securely connected to the base 20, and the first magnet 1 and the second magnet 2 are connected via the iron core 6 along the first direction.

Specifically, the iron core 6 may also be disposed between the first magnet 1 and the second magnet 2, and the coil 3 surrounds an outer periphery of the iron core 6. Since the iron core 6 is made of a ferromagnetic material and has a high magnetic permeability, when the iron core 6 is inserted inside the energized coil 3, the iron core 6 is magnetized by the magnetic field of the energized coil 3. This greatly increases the magnetic induction strength inside the iron core 6. The magnetized iron core 6 also becomes a magnet itself. Thus, the magnetic field generated by the iron core 6 may be superimposed with the magnetic fields generated by the first magnet 1 and the second magnet 2, which further enhances the magnetic field strength and enhances the drive force.

Further, referring to FIGS. 1-6, in some embodiments, the variable aperture includes a plurality of magnetic circuit structures 10 spaced apart along a circumferential direction of the base 20. By configuring a plurality of magnetic circuit structures 10, the coils 3 of the plurality of magnetic circuit structures 10 may simultaneously control a single rotatable bracket 30, which improves the drive effect on the rotatable bracket 30. Furthermore, because the plurality of magnetic circuit structures 10 are spaced apart, the drive force received by various portions of the rotatable bracket 30 along the circumferential direction is relatively balanced, thereby enabling better rotation.

Further, referring to FIGS. 1-6, in some specific embodiments, a pivot hole 402 and a slide hole 403 spaced apart from the pivot hole are defined in the blade 40. A pivot post 203 protrudes axially from a central portion of the base 20, and a connecting pin 303 protrudes axially from a body of the rotatable bracket 30. The pivot hole 402 in the blade 40 is sleeved onto the pivot post 203, and the slide hole 403 in the blade 40 is sleeved onto the connecting pin 303. Initially, after the coil 3 is energized, the connecting pin 303 of the rotatable bracket 30 interacts with the pivot hole 402 in the blade 40, such that the rotatable bracket 30 is enabled to drive the blade 40 to rotate. However, in the meantime, the pivot hole 402 in the blade 40 also rotates around the pivot post 203 of the base 20. This results in the blade 40 rotating around the pivot post 203 of the base 20 while simultaneously sliding relative to the rotatable bracket 30 along an extension direction of the slide hole 403. In this way, the size of the aperture hole 401 is adjusted.

Further, referring to FIGS. 1-6, in some specific embodiments, an accommodating space is defined between the base 20 and the rotatable bracket 30. The accommodating space is spaced apart from the first through-hole 201, and at least a portion of the magnetic circuit structure 10 is assembled within the accommodating space. Furthermore, a first slide slot 202 is defined in an outer periphery of the base 20. The first slide slot 202 is in communication with the accommodating space and extend along a circumferential direction. A first slide block 302 protrudes from a side of the rotatable bracket 30 axially facing the base 20, and the first slide block 302 is movable along the first slide slot 202. The coil 3 is securely connected to a side of the first sliding block 302 facing the accommodating space along a side radially facing away from the first magnet 1 and/or the second magnet 2.

Specifically, the base 20 may include a base body axially arranged, a central portion protruding axially from the base body, and a first side wall disposed on a periphery of the base body. The first slide slot 202 may be defined in the side wall, wherein the first through-hole 201 may be defined in the central portion. The first side wall may specifically include two protrusions that are spaced apart, and the first slide slot 202 is defined by the two protrusions. Additionally, the rotatable bracket 30 may include a bracket body axially arranged and a second side wall disposed on a periphery of the bracket body, wherein the first slide block 302 is defined on the second side wall. The accommodating space may be defined between an outer side of the central portion, an inner side of the first side wall of the base 20, and an inner side of the second side wall of the rotatable bracket 30. The coil 3, the first magnet 1, and the second magnet 2 may all be disposed within the accommodating space. Furthermore, the coil 3 may be securely connected to an inner side of the first slide block 302 of the rotatable bracket 30, thereby achieving a secure connection between the coil 3 and the rotatable bracket 30. Moreover, after the coil 3 is energized, using the center of the first through-hole 201, the second through-hole 301, and the aperture hole 401 as a rotation axis, the coil 3 may drive the rotatable bracket 30 to rotate. During the rotation, the first sliding block 302 moves within the first slide slot 202, such that the rotatable bracket 30 is enabled to rotate relative to the base 20.

Further, referring to FIGS. 1-6, in some embodiments, the variable aperture further includes a cover 50 that is secured relative to the side wall of the base 20 and is disposed to cover a side of the blades 40 facing away from the rotatable bracket 30. A third through-hole 501 that is aligned with the first through-hole 201 is defined in the cover 50. This configuration may protect the blades 40 and improve the service life of the variable aperture.

Some embodiments of the present disclosure provide a camera module. The camera module includes: a lens module and the variable aperture as described above, wherein the variable aperture is securely connected to the lens module, and the variable aperture is disposed on a light-incident side of a lens of the lens module.

Specifically, the lens module has a lens, and the variable aperture is secured to the lens module and situated on a light-incident side of the lens. In this way, by adjusting the size of the aperture hole 401 of the variable aperture, light intake of the lens may be adjusted, thereby achieving good photographic performance in different environments.

Moreover, in the embodiments of the present disclosure, the first magnet 1 and the second magnet 2 define an elongated magnet structure. Compared to a ring-shaped magnet structure, a spacing between the magnets in an elongated magnet structure may be smaller, such that a magnetic field having a greater strength is generated. Additionally, the coil 3 surrounds the outer periphery of the first magnet 1 and/or the second magnet 2, and the magnetization directions of the first magnet 1 and the second magnet 2 are opposite. This means that the magnetic poles of the first magnet 1 and the second magnet 2 at their ends proximate to each other along the first direction are the same. Furthermore, with the yoke 4 disposed on the side of the coil 3 facing away from the magnets, magnetic fields generated by the first magnet 1 and the second magnet 2 may be concentrated at the coil 3 after the coil 3 is energized. This configuration ensures that the entire coil 3 is situated within an effective region of the magnetic field, which improves magnetic field utilization and enhance the drive force. Furthermore, the rotation of the coil 3 drives rotation of the rotatable bracket 30. Compared to the magnets, the coil 3 is lighter in weight. This allows the rotation of the coil 3 and the rotatable bracket 30 to be more responsive, such that the blades 40 is better driven and the adjustment of the size of the aperture 401 is better achieved.

An electronic device is provided. The electronic device includes a camera module.

Exemplarily, the electronic device may be a mobile phone, a tablet computer, a camera, or the like. In the embodiments of the present disclosure, the first magnet 1 and the second magnet 2 define an elongated magnet structure. Compared to a ring-shaped magnet structure, a spacing between the magnets in an elongated magnet structure may be smaller, such that a magnetic field having a greater strength is generated. Additionally, the coil 3 surrounds the outer periphery of the first magnet 1 and/or the second magnet 2, and the magnetization directions of the first magnet 1 and the second magnet 2 are opposite. This means that the magnetic poles of the first magnet 1 and the second magnet 2 at their ends proximate to each other along the first direction are the same. Furthermore, with the yoke 4 disposed on the side of the coil 3 facing away from the magnets, magnetic fields generated by the first magnet 1 and the second magnet 2 may be concentrated at the coil 3 after the coil 3 is energized. This configuration ensures that the entire coil 3 is situated within an effective region of the magnetic field, which improves magnetic field utilization and enhance the drive force. Furthermore, the rotation of the coil 3 drives rotation of the rotatable bracket 30. Compared to the magnets, the coil 3 is lighter in weight. This allows the rotation of the coil 3 and the rotatable bracket 30 to be more responsive, such that the blades 40 is better driven and the adjustment of the size of the aperture 401 is better achieved.

Described above are merely exemplary embodiments of the present disclosure. It should be noted that persons of ordinary skill in the art would make various improvements without departing from the inventive concept of the present disclosure, and such improvements shall fall within the protection scope of the present disclosure.

What is claimed is:

1. A variable aperture, comprising: a base; a rotatable bracket rotatably connected to the base; a plurality of blades rotatably connected to the base and slidably connected to the rotatable bracket; and a magnetic circuit structure configured to drive the rotatable bracket to rotate, wherein a first through-hole is defined in the base, a second through-hole is defined in the rotatable bracket, and the plurality of blades enclose to define an aperture hole, the first through-hole, the second through-hole, and the aperture hole being aligned;
wherein the magnetic circuit structure comprises a first magnet and a second magnet securely connected to the base and spaced apart from each other along a first direction, a coil securely assembled to the rotatable bracket and surrounding an outer periphery of the first magnet and/or the second magnet, and a yoke secured to the base and disposed on a side of the coil facing away from the first magnet and/or the second magnet, wherein magnetization directions of the first magnet and the second magnet are opposite to each other and are both parallel to the first direction.

2. The variable aperture according to claim 1, wherein the magnetic circuit structure further comprises at least one third magnet;
wherein the third magnet is secured to one end of the first magnet along the magnetization direction of the first magnet and is assembled between the first magnet and the yoke, and a magnetization direction of the third magnet points toward the first magnet; and/or, wherein the third magnet is secured to one end of the second magnet along the magnetization direction of the second magnet and is assembled between the second magnet and the yoke, and a magnetization direction of the third magnet points toward the second magnet.

3. The variable aperture according to claim 2, wherein the yoke comprises a first yoke plate disposed on the side of the coil facing away from the first magnet;
wherein the third magnet is securely assembled between the first magnet and the first yoke plate; and/or, the third magnet is secured assembled between the second magnet and the first yoke plate.

4. The variable aperture according to claim 3, wherein the magnetization direction of the third magnet is orthogonal to the magnetization direction of the first magnet, and a magnetic pole of the third magnet at an end proximate to the first magnet is opposite to a magnetic pole of the first magnet at an end proximate to the third magnet; and/or, the magnetization direction of the third magnet is orthogonal to the magnetization direction of the second magnet, and a magnetic pole of the third magnet at an end proximate to the second magnet is opposite to a magnetic pole of the second magnet at an end proximate to the third magnet.

5. The variable aperture according to claim 3, wherein the yoke further comprises a second yoke plate connected to the first yoke plate and arranged orthogonally to the first yoke plate;
wherein the third magnet is securely assembled between the first magnet and the second yoke plate, and/or, the third magnet is securely assembled between the second magnet and the second yoke plate.

6. The variable aperture according to claim 1, wherein the magnetic circuit structure further comprises an iron core securely connected to the base, and the first magnet and the second magnet are connected via the iron core along the first direction.

7. The variable aperture according to claim 1, further comprising: a plurality of magnetic circuit structures spaced apart along a circumferential direction of the base.

8. The variable aperture according to claim 1, wherein an accommodating space is defined between the base and the rotatable bracket, the accommodating space being spaced apart from the first through-hole, and at least a portion of the magnetic circuit structure is assembled within the accommodating space; and a first slide slot is defined in an outer periphery of the base, the first slide slot being in communication with the accommodating space and extending along a circumferential direction; a first slide block protrudes from a side of the rotatable bracket axially facing the base, the first slide block being movable along the first slide slot; wherein the coil is securely connected to a side of the first slide block that faces the accommodating space along a side radially facing away from the first magnet and/or the second magnet.

9. A camera module, comprising: a lens module and the variable aperture according to claim 1, wherein the variable aperture is securely connected to the lens module, and the variable aperture is disposed on a light-incident side of a lens of the lens module.

10. An electronic device, comprising: the camera module as defined in claim 9.
